(19) United States
(12) Patent Application Publication
(10) Pub. No.: US 2022/0379927 A1
(43) Pub. Date: Dec. 1, 2022

(54) CONNECTED SYSTEMS BASED ON CONTEXTUALLY AWARE DYNAMIC VISUAL INDICATORS

(71) Applicant: AT&T Intellectual Property I, L.P., Atlanta, GA (US)

(72) Inventors: Roger D. Wickes, Gainesville, GA (US); James H. Pratt, Round Rock, TX (US); Zhi Cui, Sugar Hill, GA (US); Eric Zavesky, Austin, TX (US)

(21) Appl. No.: 17/330,051

(22) Filed: May 25, 2021

(51) Int. Cl. B60W 60/00; G07C 5/08; B60W 50/14; G05D 1/02; B60W 50/038; G04F 5/02

(52) U.S. Cl. CPC B60W 60/00186; G07C 5/0825; B60W 50/14; G05D 1/0212; B60W 50/038; G04F 5/025; B60W 2050/146; B60W 2555/20; B60W 2530/20; B60W 2520/10; B60W 2520/12; B60W 2510/0638; B60W 2510/0676

(57) ABSTRACT

In one example, a method performed by a processing system including at least one processor includes receiving a plurality of data from an autonomous driving vehicle, presenting the plurality of data in a contextually aware dynamic visual indicator, generating an output that the autonomous driving vehicle is operating improperly based on an analysis of the plurality of data, and transmitting a control signal to the autonomous driving vehicle in response to the output that the autonomous driving vehicle is operating improperly to modify an operation of the autonomous driving vehicle.

The present disclosure relates generally to connected systems, and relates more particularly to devices, non-transitory computer-readable media, and methods for providing controls for connected systems based on contextually aware dynamic visual indicators.

### BACKGROUND

Over time systems have grown in size and complexity. Some system may include many interacting subsystems or devices that generate several different types of data. Successful interaction of these subsystems can drive overall quality. In some instances, failure may result in disaster or even death of an individual.

These systems may have several to hundreds of different monitors and/or screens that can generate various data points. The data may be transmitted and/or collected at a central operations center or a monitoring device. The data may reflect the health of the overall of the system and corresponding subsystems.

### SUMMARY

In one example, a method performed by a processing system including at least one processor includes receiving a plurality of data from an autonomous driving vehicle, presenting the plurality of data in a contextually aware dynamic visual indicator, generating an output that the autonomous driving vehicle is operating improperly based on an analysis of the plurality of data, and transmitting a control signal to the autonomous driving vehicle in response to the output that the autonomous driving vehicle is operating improperly to modify an operation of the autonomous driving vehicle.

In another example, a non-transitory computer-readable medium stores instructions which, when executed by a processing system in a telecommunications network, cause the processing system to perform operations. The operations include receiving a plurality of data from an autonomous driving vehicle, presenting the plurality of data in a contextually aware dynamic visual indicator, generating an output that the autonomous driving vehicle is operating improperly based on an analysis of the plurality of data, and transmitting a control signal to the autonomous driving vehicle in response to the output that the autonomous driving vehicle is operating improperly to modify an operation of the autonomous driving vehicle.

In another example, a device includes a processor and a computer-readable medium storing instructions which, when executed by the processor, cause the processor to perform operations. The operations include receiving a plurality of data from an autonomous driving vehicle, presenting the plurality of data in a contextually aware dynamic visual indicator, generating an output that the autonomous driving vehicle is operating improperly based on an analysis of the plurality of data, and transmitting a control signal to the autonomous driving vehicle in response to the output that the autonomous driving vehicle is operating improperly to modify an operation of the autonomous driving vehicle.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example connected system of the present disclosure;

FIG. 3 illustrates an example dynamic visual indicator for conveying health status of a subsystem of the present disclosure;

FIG. 4 illustrates a flowchart of a method for controlling an autonomous vehicle based on an output from a contextually aware dynamic visual indicator, in accordance with the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure describes controls for connected systems based on contextually aware dynamic indicators. As discussed above, some systems may include many interacting subsystems or devices that generate several different types of data. Successful interaction of these subsystems can drive overall quality. In some instances, failures may result in disaster or even death of an individual.

These systems may have several to hundreds of different monitors and/or screens that can generate various data points. The data may be transmitted and/or collected at a central operations center or a monitoring device. When one or more of the systems work together, the combined and/or cascaded error of the subsystems may not be easily discernable.

Currently, the data may be analyzed by a human technician. However, understanding the health of the system by looking at all of the different monitors and data may be difficult and inefficient with a human technician. The present disclosure provides contextual aware dynamic indicators that can provide an output that can indicate the health of a subsystem based on analysis of a plurality of different contextual data associated with the subsystem. A central monitoring system or monitoring device can then control the subsystem based on the output of the contextually aware dynamic visual indicator.

An example of a connected system that can be deployed with the contextually aware dynamic visual indicators may include autonomous driving vehicles. A central monitor (e.g., a police cruiser or law enforcement vehicle) may collect various data associated with the autonomous driving vehicles (ADV) that represent the connected subsystems. The police cruiser may include a user interface that displays a contextually aware dynamic visual indicator related to the operation of the ADVs nearby. When an ADV is not operating properly (e.g., the Artificial Intelligence (AI) software driving the car is operating outside normal operating limits (e.g., missing critical updates, processor overload, sensor failure, and the like), operating against local laws or rules (broadly one or more local requirements) for ADVs (e.g., driver non-responsive to taking manual control, an overloaded ADV for a particular road, an ADV with improper tire type for a particular time of the year, etc.), a potential malfunction (e.g., an ADV with low brake fluid, an ADV with under inflated tires, etc.), and the like) the contextually aware dynamic visual indicator may generate an output that allows the officer to quickly see that the ADV is not operating properly. In response, the police cruiser may transmit a control signal to the ADV to mitigate the violation or potential malfunction of the ADV, e.g., to exit the roadway immediately, to pull over into the next available service station to address the potential malfunction, and the like.

In one embodiment, the data from the ADV may be transmitted over an access network to the police cruiser that may be monitoring a particular location or area. The control signal may be transmitted to the ADV over the same access network.

In one embodiment, a security code may be transmitted with the control signal. The security code may be provided to authorized personal (e.g., law enforcement, manufacturers, and the like) to prevent unauthorized control of the ADV from a hacker.

Although an example of ADVs is discussed above, it should be noted that the present disclosure may be applied to other connected systems. For example, the present disclosure may be applied to gaming (e.g., virtual reality headsets), farming or other agricultural data networks with autonomous vehicles or equipment, and the like.

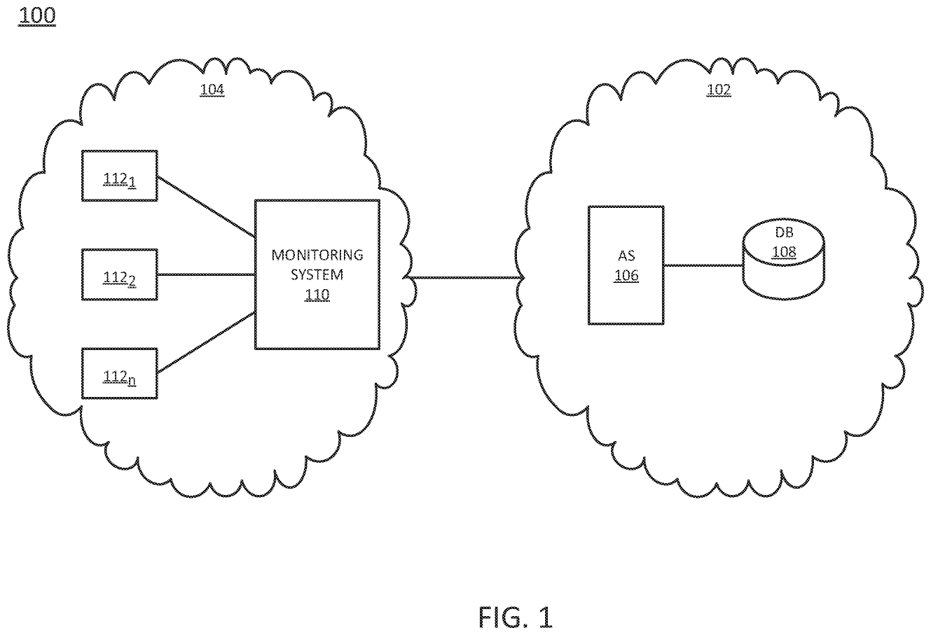

To better understand the present disclosure, FIG. 1 illustrates an example network 100, related to the present disclosure. As shown in FIG. 1, the network 100 may include a core network 102 and an access network 104. The core network 102 may include an application server (AS) 106 and a database (DB) 108. The AS 106 may be a central monitoring system that may collect and analyze data generated by monitored subsystems. The AS 106 may analyze the data to generate a contextually aware dynamic visual indicator, as discussed in further details below.

In one embodiment, the AS 106 may be communicatively coupled to a DB 108. The DB 108 may store various information, such as the data received from the monitored subsystems, security keys for control signals that are generated to control the monitored subsystems, data logs, and the like.

In one embodiment, the core network 102 may be a communications network that includes additional network elements that are not shown. For example, core network 102 may functionally comprise a fixed mobile convergence (FMC) network, e.g., an IP Multimedia Subsystem (IMS) network. In addition, core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network. The core network 102 may include additional network elements, such as gateway servers, edge routers, and the like to interconnect the core network 102 with other remote networks 104, e.g., an access network, a local area network, a wireless personal area network, etc.

In one embodiment, the access network 104 may be a wired or wireless access network. The network provides authorized users (e.g., law enforcement, system administrators, and the like) access to operate, administer, and maintain (OAM) the devices comprising the core network 102. For example, the wireless access network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the wireless access network may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations.

In one embodiment, other examples of the access network 104 may include a Digital Subscriber Line (DSL) network, a broadband cable access network, a Local Area Network (LAN), a cellular or wireless access network, a 3^{rd} party network, and the like. For example, the operator of the core network 102 may provide communication services to devices or systems via the access network 104.

In one embodiment, the access network 104 may also transmit and receive communications between devices in the access network 104 and core network 102 relating to voice telephone calls, communications with web servers via the Internet and/or other networks, and so forth.

In one embodiment, the network 104 (e.g., broadly a remote network) may include a monitoring system 110 and a plurality of subsystems 112₁ to 112ₙ (hereinafter also referred to individually as a subsystem 112 or collectively as subsystems 112). In one embodiment, the monitoring system 110 may monitor data generated by the subsystems 112 using a contextually aware dynamic visual indicator, as described in further details below. The contextually aware dynamic visual indicator may generate an output that indicates whether a subsystem 112 is operating correctly based on the plurality of different types of data generated by the subsystem 112. If the subsystem is operating incorrectly, the monitoring system 110 may generate a control signal to modify the operation of the subsystem 112 in response to the output generated by the contextually aware dynamic visual indicator.

In one embodiment, the monitoring system 110 may be in communication with the AS 106. For example, the data may be transmitted to the AS 106 managed by a service provider. The AS 106 may analyze the data, generate the contextually aware dynamic visual indicator or indicators (e.g., one for each subsystem 112) and transmit the contextually aware dynamic visual indicator to the monitoring system 110. The control signal may also be routed through the core network 102, via the AS 106, back to the subsystems 112 via the access network 104.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Similarly, the present disclosure is not limited to an IP/MPLS network for VoIP telephony services, or any particular type of broadcast television network for providing television services, and so forth.

In one embodiment, the monitoring system 110 and the subsystems 112 may be a network of computing devices playing a video game. For example, the monitoring system 110 may be a virtual reality (VR) headset that is monitoring the activity of the neighboring VR headsets (e.g., the subsystems 112) within a local location. The monitoring VR headset may collect data generated by the neighboring VR headsets. For example, the data may include movement data (location, directional vectors, and the like), calibration data (e.g., how movement is translated into movement in an application or game displayed in the VR headset), sound data, application data, and the like.

A contextually aware dynamic visual indicator may indicate that one of the neighboring VR headsets is not calibrated correctly causing a user to move too much and consistently bump into other users in the location. The monitoring VR headset may send a control signal to the neighboring VR headset to perform a calibration or to adjust a calibration routine. In response, the neighboring VR headset may perform the calibration and the contextually aware dynamic visual indicator may be updated to indicate that the neighboring VR headset has been calibrated and is now operating correctly.

In one embodiment, the monitoring system 110 and the subsystems 112 may be a local area network of agricultural devices. For example, the subsystems 112 may include sprinkler systems, irrigation systems, soil monitoring systems, moisture monitors, and the like. The monitoring system 110 may collect data generated from the subsystems 112.

Based on the data collected from the subsystems 112 a contextual aware dynamic indicator may indicate that one of the subsystems is not operating correctly to ensure optimal soil conditions for a crop to grow. The monitoring system 110 may send a control signal to a sprinkler system to modify operation of the sprinkler system (e.g., water more frequently, provide more water per watering operation, and the like).

In one embodiment, the monitoring system 110 and the subsystems 112 may be a network of artificial intelligence or machine learning systems. For example, the monitoring system 110 may collect data from several different machine learning models that analyze data to make predictions for certain systems or outcomes. The monitoring system 110 may collect data generated from the different machine learning models.

A contextually aware dynamic visual indicator may generate an output that one of the machine learning models is operating incorrectly. For example, a link to a data source may be corrupted causing the machine learning model to generate predictions that fall outside of a confidence threshold. The monitoring system may generate a control signal to reset a link to the data source used by the machine learning model. The link may be restored and the machine learning model may then again generate predictions that fall within the confidence threshold. The contextually aware dynamic visual indicator may be updated to indicate that the machine learning model is now operating correctly.

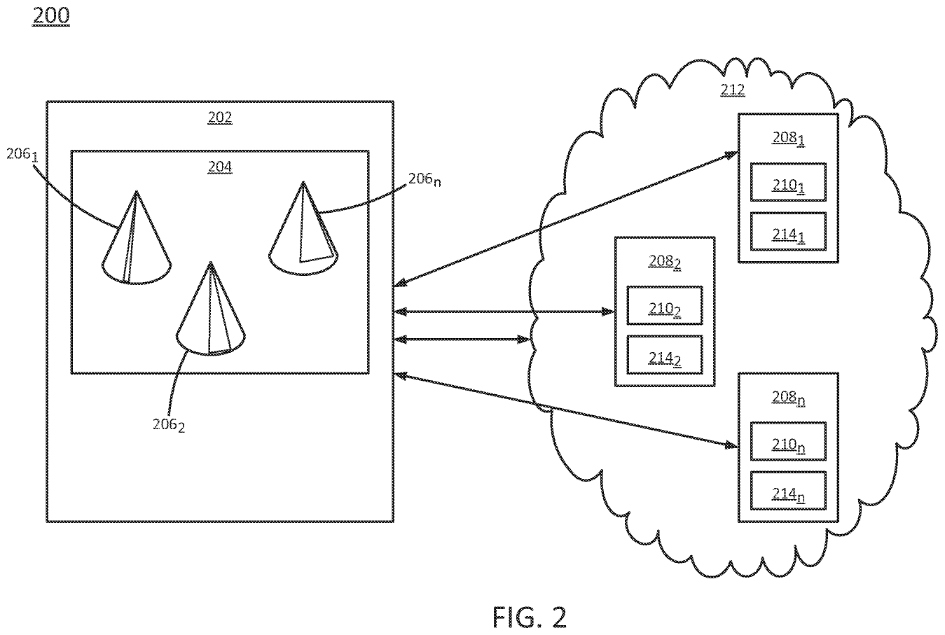

In one embodiment, the monitoring system 110 may be implemented within a police cruiser or law enforcement vehicle that is monitoring operation of a ADVs (e.g., subsystems 112). FIG. 2 illustrates a more detailed block diagram of an example connected system that includes a monitoring vehicle 202, e.g., a law enforcement vehicle or police cruiser that monitors ADVs 208₁ to 208ₙ (hereinafter also referred to individually as an ADV 208 or collectively as ADVs 208). The ADVs 208 may include a respective user interfaces 210₁ to 210ₙ (hereinafter also referred to individually as a user interface 210 or collectively as user interfaces 210) and respective sensors 214₁ to 214ₙ (hereinafter also referred to individually as a sensor 214 or collectively as sensors 214).

In one embodiment, an ADV 208 may be defined as an automobile that has self-driving capability. For example, the ADV 208 may use sensors 214 to assist in the control of steering, maintaining and/or changing speed, and various maneuvering (e.g., parking, backing up, etc.) without manual intervention or control of a driver. The sensors 214 may include sensors to collect data on the operation of various components of the ADV 208. For example, the sensors 214 of an ADV 208 may include an engine temperature sensor, a tire pressure sensor, a speedometer, a rotations per minute (RPM) sensor, a global positioning system (GPS) location sensor, a fuel level sensor, a vision camera to detect driving lanes, an object sensor to detect nearby objects and distances to the object (e.g., a radar sensor), a rain sensor, a battery level sensor, a steering rack sensor, a sensor to indicate operation of headlights, sensors to detect movement on a driver's seat, sensors to detect touch of a steering wheel, and the like.

The user interface 210 may be a graphical user interface that displays information to the driver or passenger in the ADV 208. The user interface 210 may include climate controls, radio controls, navigation controls, and the like. The user interface 210 may also display notifications and/or messages when control signals are transmitted to the ADV 208 in response to an output generated by a contextually aware dynamic visual indicator, as discussed in further details below.

In one embodiment, the police cruiser 202 may be monitoring a location 212, e.g., a portion of a roadway. The location 212 may be defined by a wireless range of an access network (e.g., the access network 104). In one embodiment the location 212 may be defined by geographic boundaries. For example, the location 212 may be a town, a particular stretch of a highway or interstate, and the like.

The police cruiser may monitor data generated by the ADVs 208 to ensure that the ADVs 208 are operating correctly or within the rules and/or regulations for ADVs 208 in the particular location 212. For example, the location 212 may have certain rules on how the ADVs 208 may operate. The rules may include a speed limit for ADVs 208, a minimum distance between an ADV 208 and a neighboring vehicle, ensuring that a driver is alert even when the ADV 208 is in an autopilot mode (e.g., hands on the steering wheel, driver sitting in the driver seat, eyes of the driver not closed for an extended period of time, etc.), and the like. The police cruiser may also monitor the data to ensure that the ADV 208 is operating safely and prevent any accidents from potential failures of sensors or devices in the ADV 208.

In one embodiment, the police cruiser 202 may include a user interface 204. The user interface 204 may be a graphical user interface that includes external input devices (e.g., a keyboard and mouse) or a touch screen. The user interface 204 may display contextually aware dynamic visual indicators 206₁ to 206ₙ (also referred to herein individually as a contextually aware dynamic visual indicator 206 or collectively as contextually aware dynamic indicators 206). In one embodiment, each contextually aware dynamic visual indicator 206₁ to 206ₙ may be associated with, or represent, one of the ADVs 208₁ to 208ₙ. For example, the contextually aware dynamic visual indicator 206₁ may represent the ADV 208₁, the contextually aware dynamic visual indicator 206₂ may represent the ADV 208₂, and the contextually aware dynamic visual indicator 206ₙ may represent the ADV 208ₙ.

The contextually aware dynamic visual indicators 206 may be a multi-dimensional graphical indicator that can summarize the various data points from the ADVs 208 and generate an output. The output may indicate whether an ADV 208 is operating properly or improperly. Thus, the contextually aware dynamic visual indicators 206 may allow an officer within the police cruiser 202 to quickly determine whether one or more of the ADVs 208 are operating improperly (e.g., about to fail or breaking a rule or regulation for the particular location 212). If one of the ADVs 208 is operating improperly, the officer may take a corrective action (e.g., drive to the ADV and address the issue, write a ticket, etc.) or the user interface 204 may automatically generate and transmit a control signal to the ADV 208 (e.g., sending a notification of the potential violation or potential failure, one or more suggested correct actions to be taken by the ADV at its discretion, one or more computer instructions directed at the ADV itself to bring about an immediate resolution, e.g., computer control instructions that automatically direct the ADV to exit the roadway, to pull over at the next safe location, and so on).

For example, the ADV 208₁ may be required to subscribe to data monitoring to allow auto pilot modes or autonomous driving. The data may be collected by the police cruiser 202 via the core network 102, illustrated in FIG. 1. The data may be analyzed by a local monitoring system comprising the user interface 204 or the AS 106 to display the contextually aware dynamic visual indicator 206₁ that represents the ADV 208₁.

For example, the sensors 214₁ may indicate a speed of the ADV 208₁. The sensors 214₁ may indicate that based on GPS data that the ADV 208₁ is about to come to a severe extended downhill curve. The sensors 214₁ may indicate that the radar sensor has not been calibrated recently and is occasionally providing inaccurate data. The sensors 214₁ may also indicate that based on the last brake service and amount of miles driven that the brake pads may be at a low limit for breaking. As a result, the monitoring system (e.g., located at the AS 106 or the police cruiser 202) may determine that a crash is potentially likely for the ADV 208₁. The contextually aware dynamic visual indicator 206₁ may generate an output that the crash or impending failure is likely or imminent.

In response, the user interface 204 or the AS 106 may generate a control signal to reduce the speed of the ADV 208₁ well in advance of the upcoming severe downhill curve. The user interface 204 may also generate a notification or message that is displayed on the user interface 210₁ notifying a driver why the control signal was issued. Once the ADV 208₁ is at the proper speed, the contextually aware dynamic visual indicator 206₁ for the ADV 208₁ may be updated to indicate that the control signal was successfully implemented and the ADV 208₁ is now operating properly.

In another example, the location 212 may have a time limit for how long auto pilot may be engaged without user interaction. For example, some locations 212 may require that the user still actively have the hands on the steering wheel and be ready to control the vehicle. Checks may be made every 5 minutes, every 10 minutes, every 30 minutes, or every hour to ensure that the user has not fallen asleep or is doing something else while behind the wheel of the ADV 208₁. The sensors 214₁ may collect data that indicate no variation in speed in the last 10 minutes. The sensors 214₁ may also collect data that indicate no movement has been detected in the driver's seat and that no touch has been detected on the steering wheel in the last 10 minutes. The contextually aware dynamic visual indicator may generate an output indicating that the driver is likely asleep.

In response, the user interface 204 may generate a control signal to modify the operation of the ADV 208₁. For example, the control signal may cause the user interface 210₁ of the ADV 208₁ to play an alarm or generate a message that requires a manual response from the driver to ensure that the driver is not asleep. In another example, the user interface 204 may generate a control signal to directly cause the ADV 208₁ to pull over to the side of the road for violating the rules within the location 212 without the assistance of the driver. For example, the control signal may cause a destination of the ADV 208₁ to be changed to a nearest safe location (e.g., a rest stop or a service area off of a highway) where the ADV 208₁ may be stopped temporarily. The police cruiser 202 may then drive up to the ADV 208₁ to interact with the driver, e.g., to assess the cause of the violation, to issue a warning, to issue a citation, and so on.

In one embodiment, the number of contextually aware dynamic visual indicators 206 on the user interface 204 may be continuously changing. For example, as ADVs 208 enter and leave the location 212, the associated contextually aware dynamic visual indicators 206 that are shown in the user interface 204 may also change or be updated.

In one embodiment, the control signal that is transmitted from the user interface 204 to the ADVs 208 may include a security key. The security key may ensure that the control signals come from a legitimate source and help to prevent hacking of the ADVs 208. The security key may be issued by the manufacturer of the car and provided to authorized personnel (e.g., the police, traffic officers, law enforcement officers, border control officers, etc.). In one embodiment, the security key may be selected by a driver of the ADV 208 and presented to the communication network service provider as part of the agreement to be monitored. In other words, in one embodiment direct control of the ADVs may only occur if positive prior consent is provided by the owners of the ADS. The communication network service provider may then provide the security key to the authorized personnel.

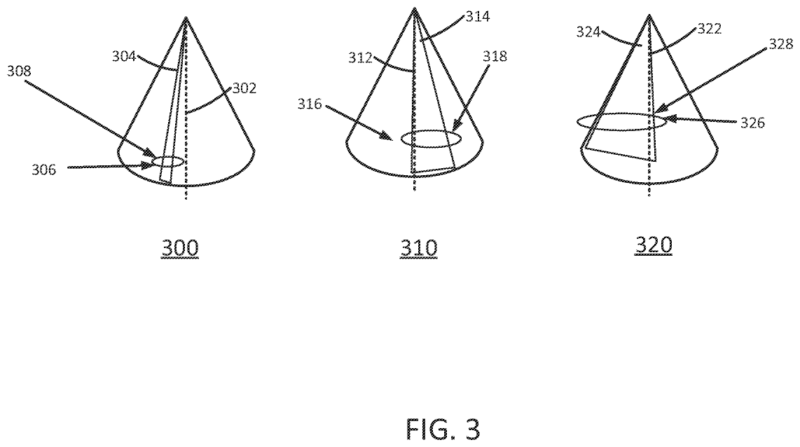

FIG. 3, for example, illustrates an example of a contextually aware dynamic visual indicator 206 of the present disclosure. In one embodiment, the contextually aware dynamic visual indicator 206 may be a metronome 300. As illustrated, the metronome 300 may comprise an origin 302 (illustrated as ninety degree vertical line) and a pendulum 304. The origin 302 may represent a first set of data. The pendulum 304 may represent a second set of data. A width 308 of the pendulum 304 may represent a third data set.

For example, the origin 302 may represent a speed limit in the location 212. A position of the pendulum 304 relative to the origin 302 may represent whether the ADV 208 is above or below the speed limit. For example, if the pendulum 304 is at the origin 302, the ADV 208 may be traveling the speed limit. If the pendulum 304 moves to the left of the origin 302 (as indicated by an arrow 306), the ADV 208 may be travelling at a speed below the speed limit. Conversely, if the pendulum 304 moves to the right of the origin 302, the ADV 208 may be travelling at a speed above the speed limit. The width 308 of the pendulum 304 may indicate an amount of time that the ADV 208 has been travelling at a speed above or below the speed limit. For example, the wider the width 308, the longer the ADV 208 has been travelling above or below the speed limit.

In one embodiment, an overall color of the metronome 300 may indicate if the ADV 208 has violated a rule in the location 212. The amount over the speed limit for a predefined duration may be set. For example, ADVs 208 that travel more than 10 miles per hour over the limit for longer than 5 minutes may receive a warning or be ticketed (e.g., temporary higher speeds may be allowed to allow for passing or to address various road and/or traffic conditions). When the conditions are met by the direction of the pendulum 304 relative to the origin 302 and the width 308 of the pendulum 304, the metronome 300 may change from green to red (or any other color combination). The metronome 300 may output that the ADV 208 may be speeding or violating a rule in the location 212 and a control signal may be generated, as described above.

When the control signal is successfully implemented by the ADV 208, updated data may be received that may dynamically change the appearance of the metronome 300. For example, the ADV 208 may reduce its speed to the speed limit and the color of the metronome 300 may be changed back from red to green to indicate that the ADV 208 is operating correctly or within the rules of the location 212.

In further examples, the metronome-style contextually aware dynamic visual indicator could also be used to provide an indicator of a potential accident. For instance, a metronome 310 may be used to visualize a condition that may trigger a potential accident. In this case, the metronome 310 may comprise an origin 312 (illustrated as ninety degree vertical line) and a pendulum 314. The origin 312 may represent a GPS location that is known to have a dangerous driving condition (e.g., an extreme downhill curve, construction crews, and the like). The pendulum 314 may indicate a current location of the ADV 208 relative to the known dangerous driving condition represented by the origin 312. A width 318 of the pendulum 314 may represent a speed of the ADV 208. Thus, when the pendulum 314 is to the right of the origin 312 (as shown by the arrow 316), the ADV 208 may be approaching the origin 312 from a westbound direction. Similarly, if the pendulum was on the left of the origin 312, the ADV 208 would be approaching from an eastbound direction. It should be noted that the position of the pendulum 314 may also be used to indicate a northbound and southbound direction as well.

In one embodiment a desired speed at a predefined distance away from the origin 312 may be set as a safe speed to travel through the known dangerous condition. When the pendulum is at a distance from the origin 312 that represents the predefined distance, a width 318 of the pendulum 314 can be checked. At the predefined distance, if the width 318 is too wide (e.g., the ADV 208 is travelling too quickly), then the color of the metronome 310 may change from green to red (or any other color combination) to indicate that a condition exists that may trigger an impending accident. In response, the monitoring system (e.g., the user interface 204 of the police cruiser 202) may generate a control signal to modify the operation of the ADV 208 to reduce the speed of the ADV 208.

When the control signal is successfully implemented by the ADV 208, updated data may be received that may dynamically change the appearance of the metronome 310. For example, the control signal may cause the ADV 208 to reduce its speed as it approaches the known dangerous location. The width 318 of the pendulum 314 may be reduced as the pendulum 314 moves closer to the origin 312. The metronome 310 may be updated to change back from red to green to indicate that the condition that may lead to an impending accident has been avoided by the ADV 208.

In further examples, a metronome 320 may be used to visualize an impending failure. In this case, the metronome 320 may comprise an origin 322 (illustrated as ninety degree vertical line) and a pendulum 324. The origin 322 may indicate a center of a driving lane captured by a camera sensor of the ADV 208. The pendulum 324 may indicate a sway of the ADV 208 (e.g., how much the ADV 208 is moving left and right of the centerline. A width 328 of the pendulum 324 may indicate a number of times the ADV 208 has swayed left or right of the origin 322.

In one embodiment, when the width 328 of the pendulum 324 is greater than a predefined width, the metronome 320 may indicate an impending failure of the autopilot due to a faulty camera, a camera with a dirty lens, a faulty alignment of the wheels, a faulty alignment of the steering column, or any other number of factors. For example, constant swaying and correction may be due to a bad sensor and/or potential mechanical issue.

In one embodiment, when the pendulum 324 moves too far in one direction (e.g., greater than a predefined distance left of the origin 322 as shown by an arrow 326), the metronome 320 may indicate an impending failure. For example, the ADV 208 may be crossing into an adjacent lane due to a mechanical failure.

In response, the metronome 320 may generate an output that a failure may be about to occur by changing from green to red. In response, the monitoring system (e.g., the user interface 204 in the police cruiser 202) may generate a control signal to modify the operation of the ADV 208. For example, the control signal may be a signal to generate a notification on the user interface 210 of the ADV 208 that the ADV 208 may have a sensor or mechanical issue causing the constant sway of the vehicle. In another example, the control signal may cause the ADV 208 to change a destination of the ADV 208. For example, the ADV 208 may be headed to an address, but due to the impending failure, the control signal may cause the ADV 208 to exit the highway and use a slower local road, to exit to a nearest rest stop or service area to inspect the ADV 208, to change the destination to a nearest mechanic or dealer to immediately correct the sensor or mechanical issue causing the sway, to inform the driver to stop using the auto-pilot mode of operation and to take manual control of the ADV 208, and so on.

When the control signal is successfully implemented by the ADV 208, updated data may be received that may dynamically change the appearance of the metronome 320. For example, the driver may acknowledge the notification or the ADV 208 may arrive at a mechanic. The width 328 of the pendulum 324 may be reset to a minimum width and the pendulum 324 may return to the origin 322. The metronome 320 may be updated to change back from red to green to indicate that the impending failure will be avoided by the ADV 208.

Although the contextually aware dynamic visual indicator is shown as various metronomes 300, 310, and 320, it should be noted that the contextually aware dynamic visual indicator may be shown in other graphical representations. For example, for more complex analysis, each sensor may be shown as a red or green box. The overall status of the ADV 208 may then be determined by an outer colored box. For example, various sensors that indicate whether or not a driver is asleep may turn red when no movement is detected, no touch is detected on the steering wheel, and the car has not changed lanes for a predefined amount of time. The outer colored box may turn red to indicate that the driver has likely fallen asleep or is not attentive behind the wheel during an autopilot mode of operation.

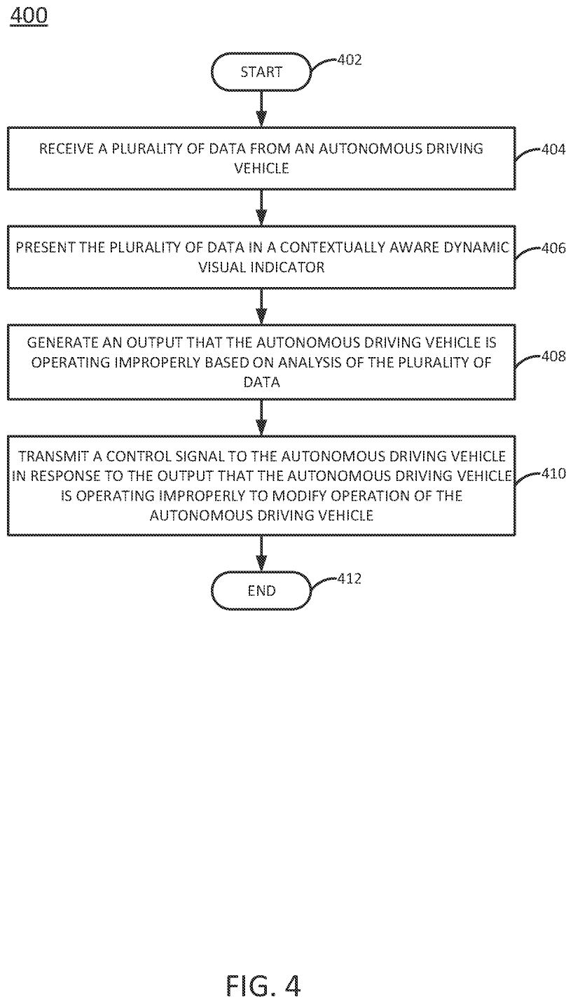

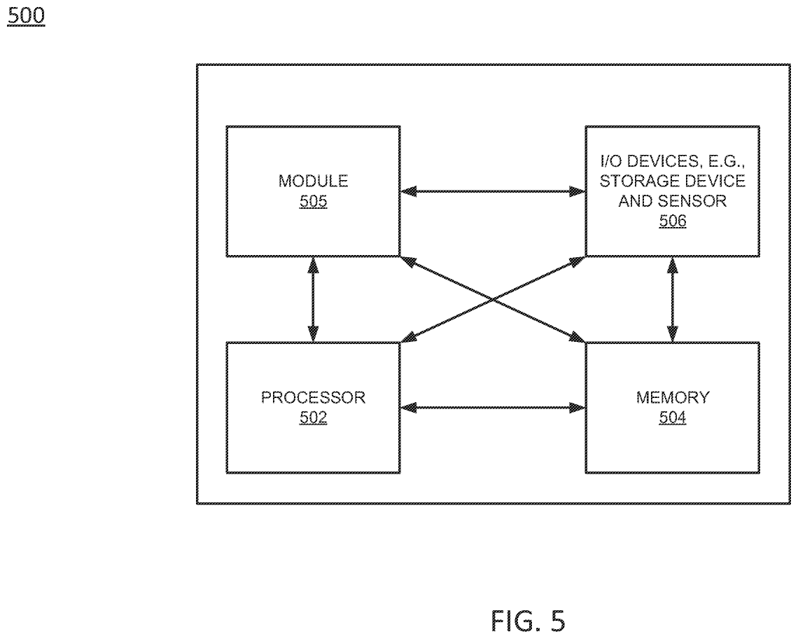

To further aid in understanding the present disclosure, FIG. 4 illustrates a flowchart of a method 400 for controlling an autonomous vehicle based on an output from a contextually aware dynamic visual indicator, in accordance with the present disclosure. In one example, the method 400 may be performed by a monitoring system 110 or the AS 106, illustrated in FIG. 1 or the user interface 204 of the police cruiser 202 illustrated in FIG. 2. However, in other examples, the method 400 may be performed by another device, such as the processor 502 of the system 500 illustrated in FIG. 5.

The method 400 begins in step 402. In step 404, the processing system may receive plurality of data from an autonomous driving vehicle. In one embodiment, the processing system may be a monitoring system with a graphical user interface located inside of a monitoring vehicle, e.g., a law enforcement vehicle, a police cruiser, a traffic officer cruiser, and the like. In one embodiment, the monitoring system can be deployed in any monitoring vehicle or station that is tasked with monitoring the operations of ADVs 208 on a roadway. Thus, the monitoring vehicle does not need to be a police cruiser, but may simply be a monitoring vehicle operated by an official (broadly an authorized human operator) with the proper jurisdiction over the pertinent stretch of roadway. In one illustrative embodiment, the monitoring vehicle could also itself be an ADV. The monitoring system may monitor autonomous driving vehicles within a particular location or jurisdiction or may monitor autonomous driving vehicles that are within wireless range of an access network connected to the monitoring system.

In one embodiment, the data may be generated from operational sensor data from the autonomous driving vehicles. The operational sensor data may be generated from various sensors on the autonomous driving vehicles that may monitor different components and/or aspects of the autonomous driving vehicles. The operational sensor data may include: operational software version for that make and model, various distance measurements (e.g., distance between vehicles, distance relative to lane markers or lines, distance to an upcoming road condition, distance to a rest stop, etc.), speed or acceleration of the autonomous driving vehicle, activation of a rain sensor, tire pressure data, fuel level data, braking data (e.g., braking distance per brake application, braking effectiveness, applied braking pressure per brake application, brake pad thickness, and the like), GPS movement tracking data (broadly location tracking data), engine temperature data, engine rotations per minute data, steering wheel touch sensor data, seat movement sensor data, images from a video camera, and the like.

In step 406, the processing system may present the plurality of data in a contextually aware dynamic visual indicator. In one embodiment, the contextually aware dynamic visual indicator may display the sensor data visually so that a user may quickly view the sensor data associated with an autonomous driving vehicle. The contextually aware dynamic visual indicator may be a three-dimensional indicator to present the plurality of data simultaneously. For example, the contextually aware dynamic visual indicator may represent different sets of data in the different dimensions, movements of portions of the three-dimensional indicator, and/or different portions of the three-dimensional indicator. The three-dimensional indicator can be rotated, moved, and/or manipulated to view different portions of the three-dimensional indicator to see the different sets of data shown by the three-dimensional indicator.

In one embodiment, the contextually aware dynamic visual indicator may be presented as a metronome. The metronome may have an origin and a pendulum. The origin may represent a first set of data and the pendulum may represent a second set of data.

In one embodiment, a width of the pendulum may represent a third set of data. For example, the width of the pendulum may dynamically change as a set of sensor data changes.

In one embodiment, the movement of the pendulum may represent a fourth set of data. For example, the pendulum may move left and right relative to the origin and a distance of the pendulum away from the origin may represent a set of data and/or a velocity of the movement of the pendulum may represent another set of data.

In one embodiment, the graphical user interface of the monitoring system may display a plurality of contextually aware dynamic visual indicators. For example, each autonomous driving vehicle in a location that is being monitored may be represented by a respective contextually aware dynamic visual indicator. In other words, if there are 10 autonomous driving vehicles in a monitored location, the graphical user interface may display 10 contextually aware dynamic visual indicators.

In one embodiment, the graphical user interface may be continuously updated with a different number of contextually aware dynamic visual indicators as autonomous driving vehicles enter and leave the monitored location. The contextually aware dynamic visual indicators may move in the graphical user interface in a same direction as the autonomous driving vehicle is moving. The contextually aware dynamic visual indicators may also be spaced relative to one another in the graphical user interface as the autonomous driving vehicles are spaced within the monitored location to provide more context and information to a law enforcement official, an officer and/or a monitoring official.

In step 408, the processing system may generate an output that an autonomous driving vehicle is operating improperly based on an analysis of the plurality of data. For example, the monitoring system may analyze the various sensor data that is collected from the autonomous driving vehicle. For example, the plurality of data is compared to a set of standardized measures such as: software/firmware version installed in the ADV versus the manufactures' recommended version upgrade/recall list (e.g., the ADV did not download a critical over-the-air patch), speed limit for an area, weight limit for each type of vehicle, tire pressure limit, brake pad thickness limit, braking effectiveness limit, distance separation between vehicles limit, lane departure limit, lane maintenance limit, fuel capacity limit, electric charge limit, time duration of one or more hands detected on the steering wheel limit, and the like. The differences resulting from the data comparisons can be evaluated against various predefined thresholds. When a difference exceeds an associated threshold, then the method may determine that at least one data difference warrants an output that the autonomous driving vehicle is operating improperly. The contextually aware dynamic visual indicator may then change appearance to indicate that the autonomous driving vehicle is operating improperly. In other words, the output that is generated may be displayed by a change in appearance of the contextually aware dynamic visual indicator. For example, the contextually aware dynamic visual indicator may change an overall color from green to red to indicate that the autonomous driving vehicle is operating improperly. In another example, the contextually aware dynamic visual indicator may flash to indicate that the autonomous driving vehicle is operating improperly. In another example, the contextually aware dynamic visual indicator may change shapes to indicate that the autonomous driving vehicle is operating improperly.

In one embodiment, “operating improperly” is defined as violating a rule or regulation associated with a particular location that is being monitored by the processing system, detecting an impending failure, or detecting an impending accident. For example, the location may have certain rules or regulations for autonomous driving vehicles or vehicles that use auto pilot controls. For example, the rules may require a lower speed limit for autonomous driving vehicles, processor and memory utilization below a certain limit, software/firmware versions within a range of available updates, a minimum distance from other vehicles, may require the driver to keep his or her hands on the wheel and stay alert even when the auto pilot controls are engaged, and so forth.

In one embodiment, the impending failure or accident may be based on a correlation of various sensor data that is analyzed. For example, constant swaying within a lane may indicate that a camera of the autonomous driving vehicle may need to be calibrated or that the vehicle has an alignment issue.

In another example, the sensor data may indicate that the autonomous driving vehicle is driving in a rain storm (e.g., wiper activation, moisture sensed on a road surface or on the tires, images capturing rain fall, etc.). Moreover, the sensor data may indicate that the autonomous driving vehicle is driving at a high rate of speed. In addition, the sensor data may indicate that the brake pads have not been replaced and are running low or thin and that the tire pressure is low in two of the tires. Moreover, GPS data may indicate that the autonomous driving vehicle is approaching a sharp curve. Given a current combination of sensor data, the monitoring system may determine that the autonomous driving vehicle may potentially suffer a crash at the sharp curve if it maintains the current rate of speed given the wet driving conditions, low tire pressure, and the reduced effectiveness of the brake pads. Thus, the contextually aware dynamic visual indicator may generate an output that indicates the autonomous driving vehicle is not operating properly.

In step 410, the processing system may transmit a control signal to the autonomous driving vehicle in response to the output that the autonomous driving vehicle is operating improperly to modify the current operation of the autonomous driving vehicle. For example, the control signal may cause an alarm or message to be displayed on the user interface of the autonomous driving vehicle. The alarm or message is intended to alert a passenger or driver of the autonomous driving vehicle to the conditions that resulted in the assessment that the autonomous driving vehicle is not operating properly. In one embodiment, the monitoring system may receive an acknowledgment signal from the autonomous driving vehicle regarding the receipt of the warning alarm or message, e.g., an acknowledgment signal generated by a human occupant (e.g., a driver or a passenger) of the autonomous driving vehicle. In another embodiment, the monitoring system may receive an acknowledgment signal only from the autonomous driving vehicle itself regarding the receipt of the warning alarm or message, e.g., if the warning message is merely indicating that the remaining fuel capacity (or electric charge) may warrant filling up the gas tank (or charging an electric vehicle) as soon as possible given the dearth of gas stations (or charging stations) in the coming stretches of roadways, e.g., in an extended sparsely populated area or unpopulated area.

In one embodiment, the control signal may bring about an immediate change in the operation of the autonomous driving vehicle, e.g., to dynamically change a speed of the autonomous driving vehicle. For example, the control signal may cause the autonomous driving vehicle to reduce speed to reach an allowable speed limit, to maintain a proper distance to an adjacent vehicle, or to avoid a potential accident at an upcoming dangerous curve or construction zone. In one embodiment, if the violation is significant, the control signal may even cause the autonomous driving vehicle to stop at a safe location to allow the police officer or law enforcement agent to drive up to issue a warning or a citation.

In one embodiment, the control signal may be to change a destination of the autonomous driving vehicle. For example, the control signal may cause the autonomous driving vehicle to change a destination to a nearest mechanic to correct an impending failure.

In one embodiment, the control signal may be sent with a security key to prevent unauthorized control. The security key may be issued by the manufacturer or may be selected by an owner of the car. The security key may then be sent to the law enforcement agencies as part of an agreement to allow monitoring when operating an autonomous driving vehicle or autopilot feature in a vehicle. For example only, a state or local governmental agency may only allow autonomous driving vehicles to operate at certain locations where the present remote monitoring is also authorized by the owners of the autonomous driving vehicles. This will allow a certain level of confidence that autonomous driving vehicles will all be operated in a safe and consistent manner for such locations.

In one embodiment, after the control signal is sent, the processing system may receive updated data in response to the operation of the autonomous driving vehicle being modified by the control signal. The output of the contextually aware dynamic visual indicator may then be updated to indicate that the vehicle is operating properly now based on the updated data. In step 412, the method 400 ends.

Although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 400 may be implemented as the system 500. For instance, any of the user endpoint devices described in connection with FIG. 1 or the monitoring system described in connection with FIG. 2 (such as might be used to perform the method 400) could be implemented as illustrated in FIG. 5.

As depicted in FIG. 5, the system 500 comprises a hardware processor element 502, a memory 504, a module 505 for controlling an autonomous vehicle based on an output from a contextually aware dynamic visual indicator, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for controlling an autonomous vehicle based on an output from a contextually aware dynamic visual indicator. The input/output devices 506 may include, for example, a camera, a video camera, storage devices (including but not limited to, solid state drives, bubble memory, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for controlling an autonomous vehicle based on an output from a contextually aware dynamic visual indicator (e.g., a software program comprising computer-executable instructions) can be loaded into memory 504 and executed by hardware processor element 502 to implement the steps, functions or operations as discussed above in connection with the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for controlling an autonomous vehicle based on an output from a contextually aware dynamic visual indicator (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor, a plurality of data from an autonomous driving vehicle;
presenting, by the processing system, the plurality of data in a contextually aware dynamic visual indicator;
generating, by the processing system, an output that the autonomous driving vehicle is operating improperly based on an analysis of the plurality of data; and
transmitting, by the processing system, a control signal to the autonomous driving vehicle in response to the output that the autonomous driving vehicle is operating improperly to modify an operation of the autonomous driving vehicle.

2. The method of claim 1, wherein the processing system comprises a monitoring system with a graphical user interface located on a monitoring vehicle.

3. The method of claim 2, wherein the graphical user interface is to display a plurality of contextually aware dynamic visual indicators, wherein each one of the plurality of contextually aware dynamic visual indicators represents a respective autonomous driving vehicle that is monitored by the monitoring system.

4. The method of claim 1, wherein the plurality of data comprises operational sensor data from the autonomous driving vehicle.

5. The method of claim 4, wherein the sensor data comprises at least two of: distance data, speed data of the autonomous driving vehicle, activation data of a rain sensor, tire pressure data, fuel level data, location tracking data, engine temperature data, engine rotations per minute data, or steering wheel touch sensor data.

6. The method of claim 1, wherein the contextually aware dynamic visual indicator comprises a three-dimensional indicator to present the plurality of data simultaneously.

7. The method of claim 1, wherein the contextually aware dynamic visual indicator comprises a graphic in a form of a metronome.

8. The method of claim 7, wherein the metronome comprises an origin that represents a first set of data of the plurality of data that is received.

9. The method of claim 8, wherein the metronome comprises a pendulum that represents a second set of data of the plurality of data that is received.

10. The method of claim 9, wherein a width of the pendulum represents a third set of data of the plurality of data that is received.

11. The method of claim 10, wherein a color of the metronome represents the output to indicate whether the autonomous driving vehicle is operating improperly.

12. The method of claim 1, wherein a determination that the autonomous driving vehicle is operating improperly is based on a local requirement associated with the autonomous driving vehicle at a particular location.

13. The method of claim 1, wherein a determination that the autonomous driving vehicle is operating improperly is based on an impending failure that is detected based on the plurality of data that is analyzed.

14. The method of claim 1, wherein the control signal is to generate an audible alarm on a user interface of the autonomous driving vehicle for an occupant of the autonomous driving vehicle.

15. The method of claim 1, wherein the control signal is to change a speed of the autonomous driving vehicle.

16. The method of claim 1, wherein the control signal is to change a destination of the autonomous driving vehicle.

17. The method of claim 1, further comprising:
transmitting, by the processing system, a security key with the control signal.

18. The method of claim 1, further comprising:
receiving, by the processing system, updated data in response to the operation of the autonomous driving vehicle being modified by the control signal; and
updating, by the processing system, the output of the contextually aware dynamic visual indicator to indicate that the autonomous driving vehicle is operating properly based on the updated data.

19. A non-transitory computer-readable medium storing instructions which, when executed by a processing system, cause the processing system to perform operations, the operations comprising:
receiving a plurality of data from an autonomous driving vehicle;
presenting the plurality of data in a contextually aware dynamic visual indicator;
generating an output that the autonomous driving vehicle is operating improperly based on an analysis of the plurality of data; and
transmitting a control signal to the autonomous driving vehicle in response to the output that the autonomous driving vehicle is operating improperly to modify an operation of the autonomous driving vehicle.

20. A device comprising:
a processor; and
a non-transitory computer-readable medium storing instructions which, when executed by the processor, cause the processor to perform operations, the operations comprising:
receiving a plurality of data from an autonomous driving vehicle;
presenting the plurality of data in a contextually aware dynamic visual indicator;
generating an output that the autonomous driving vehicle is operating improperly based on an analysis of the plurality of data; and
transmitting a control signal to the autonomous driving vehicle in response to the output that the autonomous driving vehicle is operating improperly to modify an operation of the autonomous driving vehicle.
